(19) United States
(12) Patent Application Publication
(10) Pub. No.: US 2024/0045744 A1
(43) Pub. Date: Feb. 8, 2024

(54) ACCELERATOR ADAPATION LAYER (AAL) PROFILE QUEUES FOR INLINE ACCELERATION OF LAYER 1

(71) Applicant: Telefonaktiebolaget LM Ericsson (publ), Stockholm (SE)

(72) Inventor: Christopher RICHARDS, Ottawa (CA)

(21) Appl. No.: 18/005,087

(22) PCT Filed: Jul. 9, 2021
(86) PCT No.: PCT/IB2021/056203

§ 371 Date: Jan. 11, 2023

Related U.S. Application Data
(60) Provisional application No. 63/052,099, filed on Jul. 15, 2020.

(51) Int. Cl. G06F 9/54

(52) U.S. Cl. CPC G06F 9/546; G06F 9/545

(57) ABSTRACT

A method, system and apparatus are disclosed. According to one or more embodiments, a node for managing data exchange between a first communication layer-second communication layer interface and a plurality of hardware accelerator queues is provided. The first layer is different from the second communication layer. The node including processing circuitry configured to: receive a first messaging from the first communication layer-second communication layer interface, determine that the first messaging is associated with at least one predefined messaging characteristic, and communicate the first messaging to a first hardware accelerator queue of the plurality of hardware accelerator queues based on the at least one predefined messaging characteristic of the first messaging.

### TECHNICAL FIELD

The present disclosure relates to wireless communications, and in particular, to mapping of accelerator abstraction layer (AAL) hardware to AAL queue assignments and/or mapping of physical layer 1 software and AAL hardware and/or providing a logical structure for separating cell control plane messages from user path data.

### BACKGROUND

The Open Radio Access Network (O-RAN) Alliance organization is developing specifications for Third Generation Partnership Project (3GPP) Radio Access Network (RAN) with the goal of disaggregating the RAN (and making those RAN interfaces open and multi-vendor capable) and separating the RAN software functions from the physical hardware that the software functions execute on by defining open interfaces between the hardware and software.

On such software—hardware interface O-RAN is defining between Open Systems Interconnection (OSI) layer 2 software and hardware based layer 1 accelerators. This is called O-RAN Accelerator Abstraction Layer (AAL) in O-RAN. In particular, there are a set of possible mappings between existing layer 2-layer 1 interface messages/signals and O-RAN AAL queues. Most of the possible mappings have little practical utility and may not be used and/or implemented in wireless communication. The useful mapping(s) may be defined in O-RAN AAL Application Programing Interface (API) specifications and used by software and hardware RAN vendors that implement O-RAN AAL inline acceleration.

O-RAN is also defining AAL APIs so that layer 2 software can utilize hardware based accelerators. These O-RAN APIs are the definition to a new interface. The O-RAN AAL APIs may include generic functions to create, configure and use software queue structures that are shared between the physical layer 1 software and the hardware based accelerators.

The queue definitions in O-RAN AAL specifications may be generic, e.g., only defining generic actions that can be performed on a queue such as enqueue an item, dequeue and item, configure queue, etc. and not defining what data the queues may transport. In other words, how these queues are assigned to transfer data between physical layer 1 software and vendor hardware accelerator implementations may be left to the vendors. One open implementation for one type of “look-aside” hardware acceleration is defined by the Data Plane Development Kit (DPDK) organization. This definition assigns specific data objects to specific queues.

For another set of O-RAN hardware based accelerators, termed “inline AAL devices” there are currently no defined O-RAN AAL queue assignments and there may be many possible variations of queue assignment. However, there may only be a small set of queue assignments that are likely to work well in practice and be widely used.

FIG. 1 is a block diagram that illustrates an example of the O-RAN SW and HW functions of a node-DU (that is the layer 2 and layer 1 functions and supporting networking functions, e.g., fronthaul) that includes inline hardware acceleration of the Long Term Evolution (LTE) or New Radio (NR) layer 1 PHY function.

On the left of FIG. 1 there is illustrated layer 2 and associated SW (labeled “L2+”), e.g., Third Generation Partnership Project (3GPP) NR or LTE MAC, scheduler, etc. This SW executes on a central processing unit (CPU) compute platform. Towards the middle of FIG. 1 there is illustrated the accelerator interface that is also executed on a CPU compute platform where the CPU may be the same CPU as the layer 2 (L2)+ software (SW) or it may be different a different CPU. The interface between the L2+SW and the L1 accelerator interface is labelled “L1/L2 Msg*” in FIG. 1.

FIG. 2 is a diagram that illustrates an example of the logical components of a HW accelerated O-RAN network function. Different types of AAL HW are supported by different AAL Profiles. The common AAL profile (labelled “AAL” in FIG. 2) is applicable to all HW accelerator types. This profile contains the APIs that are common for all AAL profile types, e.g., initialize an AAL device, configure an AAL device, start/stop an AAL device. The common AAL API includes how to manage the memory queues that are used for information passing between an instance of the O-RAN network function and the AAL device.

FIG. 3 is an example high level block diagram of an O-RAN node-DU (e.g., distributed unit) network function that utilizes an inline AAL HW accelerator device that uses the AAL queue APIs Enqueue & Dequeue to pass information between the L2+ application SW and the AAL device.

FAPI (e.g., femto application platform interface) is an open standard interface that defines messaging and procedures for information exchange between a 3GPP LTE or New Radio (NR, also referred to as 5^{th} Generation (5G)) layer 2 function (MAC) and a layer 1 PHY function. In 3GPP Release 15, this is referred to as the “Option 6” interface as illustrated in FIG. 4. The Small Cell Forum (SCF) has defined interface specifications for this interface called FAPI (femto application platform interface) and nFAPI (networked Femto API). Some SCF specifications are listed below:
SCF LTE FAPI & nFAPI specs. SCF082.09.05 Release 9 (18-05-2017)
SCF 5G FAPI: 222.10.01, 5G FAPI: PHY API Specification, v10, June 2019
SCF 5G FAPI: 222.10.03, 5G FAPI: PHY API Specification, May 2021
SCF 5G nFAPI: 225.2.0, 5G nFAPI specifications, May 2021

Within the FAPI interface, FAPI specifications define two sub-interfaces: P5 and P7. P5 is used for Configuration procedures to handle the management of the PHY layer and are expected to occur infrequently, e.g., cell management. P7 is used for the 3GPP user- and control-plane messaging and the slot procedures which determine the structure of each slot, e.g., the actual data to be transmitted such as broadcast channel (BCH), physical downlink control channel (PDCCH), physical downlink shared channel (PDSCH), physical uplink shared channel (PUSH), physical uplink control channel (PUCCH), etc.

Each cell (Sector Carrier) has its own physical layer (PHY) API/PHY instance.

The “PHY API” illustrated in the example of FIG. 5 corresponds to the “L2/L1 Interface” in FIG. 3 and not to the AAL device API interface (which would logically exist between the “PHY API” block and the “PHY” block in FIG. 5.

The FAPI specifications define the following messages that are passed between the layer 1 function and the layer 2 function:
FAPI C-Plane & U-Plane Messages (P7):
   Downlink (DL) (L2→L1): DL_TTI.Request, TX_DATA.Request, UL_DCI.Request, UL_TTI.Request
   Uplink (UL) (L1→L2): SLOT.Indication, CRC.Indication, RX_DATA.Indication, UCI.Indication, RACH.Indication, SRS.Indication, ERROR.Indication
FAPI Configuration Messaging (P5):
   DL (L2→L1): PARAM.request, CONFIG.request, START.request, STOP.request
   UL (L1→L2): PARAM.response, CONFIG.response, STOP.Indication, ERROR.Indication

For the type of O-RAN “inline” AAL hardware based accelerators there are currently no defined O-RAN AAL queue assignments. Hence, existing O-RAN based systems may not realize the full potential of O-RAN inline AAL hardware based accelerators.

### SUMMARY

Some embodiments advantageously provide methods, systems, and apparatuses for mapping of AAL hardware to AAL queue assignments and/or mapping of physical layer 1 software and AAL hardware and/or providing a logical structure for separating cell control plane messages from user path data.

In one or more embodiments, the most useful assignment of queues to different data types that may be transferred between the physical layer 1 software and vendor hardware accelerator for inline AAL based devices are defined.

One or more embodiments of the assignments described herein may be included in the O-RAN AAL API specifications.

Once the inline queue assignments are included in the O-RAN AAL API specifications, all physical layer 1 software implementations and layer 1 vendor hardware accelerator devices that want to utilize O-RAN inline AAL APIs may have to implement (at least one or more of) the queue assignment(s) defined in the O-RAN AAL API specifications.

Examples are provided herein using the Small Cell Forum FAPI message definitions. However, the disclosure covers any layer 2—layer 1 messaging/data exchange for O-RAN AAL inline acceleration.

According to one aspect of the disclosure, a node for managing data exchange between a first communication layer-second communication layer interface and a plurality of hardware accelerator queues is provided. The first layer is different from the second communication layer. The node includes processing circuitry configured to: receive a first messaging from the first communication layer-second communication layer interface, determine that the first messaging is associated with at least one predefined messaging characteristic, and communicate the first messaging to a first hardware accelerator queue of the plurality of hardware accelerator queues based on the at least one predefined messaging characteristic of the first messaging.

According to one or more embodiments of this aspect, the at least one predefined messaging characteristic is associated with at least one of: one of uplink and downlink messaging, cell specific messaging, and sub-interface type messaging. According to one or more embodiments of this aspect, the first messaging is one of: physical downlink shared channel, PDSCH, messaging, physical downlink control channel, PDCCH, messaging, physical broadcast channel, PBCH, messaging, and reference signal messaging. According to one or more embodiments of this aspect, each of the plurality of hardware accelerator queues are associated with one of a plurality of respective groups of messaging characteristics where the communicating of messaging from the first communication layer-second communication layer interface to one of the plurality of hardware accelerator queues is based on whether the messaging corresponds to one of the plurality of respective groups of messaging characteristics.

According to one or more embodiments of this aspect, a first group of messaging characteristics of the plurality of respective groups of messaging characteristics for the first hardware accelerator queue corresponds to uplink messaging for sub-interface messaging for a plurality of cells, and a second group of messaging characteristics of the plurality of respective groups of messaging characteristics for a second hardware accelerator queue of the plurality of hardware accelerator queues corresponds to downlink messaging for sub-interface messaging for a plurality of cells. According to one or more embodiments of this aspect, each hardware accelerator queue of the plurality of hardware accelerator queues is associated with a respective one of uplink and downlink messaging of a respective cell. According to one or more embodiments of this aspect, the respective one of uplink and downlink messaging includes: a first sub-interface messaging associated with the first communication layer, and a second sub-interface messaging associated with the first communication layer.

According to one or more embodiments of this aspect, the respective one of uplink and downlink messaging includes only one of: a first sub-interface messaging associated with the first communication layer, and a second sub-interface messaging associated with the first communication layer. According to one or more embodiments of this aspect, the first sub-interface messaging corresponds to femto application platform interface, FAPI, P5 messaging and the second sub-interface messaging corresponds to FAPI P7 messaging. According to one or more embodiments of this aspect, the plurality of hardware accelerator queues corresponds to first communication layer hardware accelerator queues for performing inline interface processing.

According to one or more embodiments of this aspect, the node is configured to be pluggable into a server to manage the data exchange between the first communication layer-second communication layer interface of the server and the plurality of hardware accelerator queues of the server. According to one or more embodiments of this aspect, the node is configured to be pluggable into a network node to manage the data exchange between the first communication layer-second communication layer interface of the network node and the plurality of hardware accelerator queues of the network node. According to one or more embodiments of this aspect, the first communication layer corresponds to open systems interconnection, OSI, layer 1 and the second communication layer corresponds to open systems interconnection, OSI, layer 2.

According to another aspect of the disclosure, a method implemented by a node for managing data exchange between a first communication layer-second communication layer interface and a plurality of hardware accelerator queues is provided. The first layer is different from the second communication layer. A first messaging is received from the first communication layer-second communication layer interface. A determination is made that the first messaging is associated with at least one predefined messaging characteristic. The first messaging is communicated to a first hardware accelerator queue of the plurality of hardware accelerator queues based on the at least one predefined messaging characteristic of the first messaging.

According to one or more embodiments of this aspect, the at least one predefined messaging characteristic is associated with at least one of: one of uplink and downlink messaging, cell specific messaging, sub-interface type messaging. According to one or more embodiments of this aspect, the first messaging is one of: physical downlink shared channel, PDSCH, messaging, physical downlink control channel, PDCCH, messaging, physical broadcast channel, PBCH, messaging, and reference signal messaging. According to one or more embodiments of this aspect, each of the plurality of hardware accelerator queues are associated with one of a plurality of respective groups of messaging characteristics where the communicating of messaging from the first communication layer-second communication layer interface to one of the plurality of hardware accelerator queues is based on whether the messaging corresponds to one of the plurality of respective groups of messaging characteristics.

According to one or more embodiments of this aspect, a first group of messaging characteristics of the plurality of respective groups of messaging characteristics for the first hardware accelerator queue corresponds to uplink messaging for sub-interface messaging for a plurality of cells, and a second group of messaging characteristics of the plurality of respective groups of messaging characteristics for a second hardware accelerator queue of the plurality of hardware accelerator queues corresponds to downlink messaging for sub-interface messaging for a plurality of cells. According to one or more embodiments of this aspect, each hardware accelerator queue of the plurality of hardware accelerator queues is associated with a respective one of uplink and downlink messaging of a respective cell. According to one or more embodiments of this aspect, the respective one of uplink and downlink messaging includes: a first sub-interface messaging associated with the first communication layer, and a second sub-interface messaging associated with the first communication layer.

According to one or more embodiments of this aspect, the respective one of uplink and downlink messaging includes only one of: a first sub-interface messaging associated with the first communication layer, and a second sub-interface messaging associated with the first communication layer. According to one or more embodiments of this aspect, the first sub-interface messaging corresponds to femto application platform interface, FAPI, P5 messaging and the second sub-interface messaging corresponds to FAPI P7 messaging. According to one or more embodiments of this aspect, the plurality of hardware accelerator queues corresponds to first communication layer hardware accelerator queues for performing inline interface processing.

According to one or more embodiments of this aspect, the node is configured to be pluggable into a server to manage the data exchange between the first communication layer-second communication layer interface of the server and the plurality of hardware accelerator queues of the server. According to one or more embodiments of this aspect, the first communication layer corresponds to open systems interconnection, OSI, layer 1 and the second communication layer corresponds to open systems interconnection, OSI, layer 2.

According to another aspect of the disclosure, a computer readable medium is provided. The computer readable medium includes instructions that when executed by a processor cause the processor to receive a first messaging from the first communication layer-second communication layer interface, determine that the first messaging is associated with at least one predefined messaging characteristic, and communicate the first messaging to a first hardware accelerator queue of a plurality of hardware accelerator queues based on the at least one predefined messaging characteristic of the first messaging.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a block diagram of O-RAN software and hardware functions of a node-DU;

FIG. 2 is a block diagram of logical components of a hardware accelerated O-RAN network function;

FIG. 3 is a block diagram of a high level O-RAN node-DU function;

FIG. 4 is a block diagram of higher layer to lower layer DL split options;

FIG. 5 is a block diagram of logical node functions;

FIG. 6 is a schematic diagram of an example network architecture according to the principles in the present disclosure;

FIG. 7 is a block diagram of a node according to some embodiments of the present disclosure;

FIG. 8 is a flowchart of an example process in a management node according to some embodiments of the present disclosure;

FIG. 9 is a flowchart of another example process in a management node according to some embodiments of the present disclosure;

FIG. 10 is a diagram of an example mapping according to some embodiments of the present disclosure;

FIG. 11 is a diagram of another example mapping according to some embodiments of the present disclosure; and

FIG. 12 is a diagram of yet another example mapping according to some embodiments of the present disclosure.

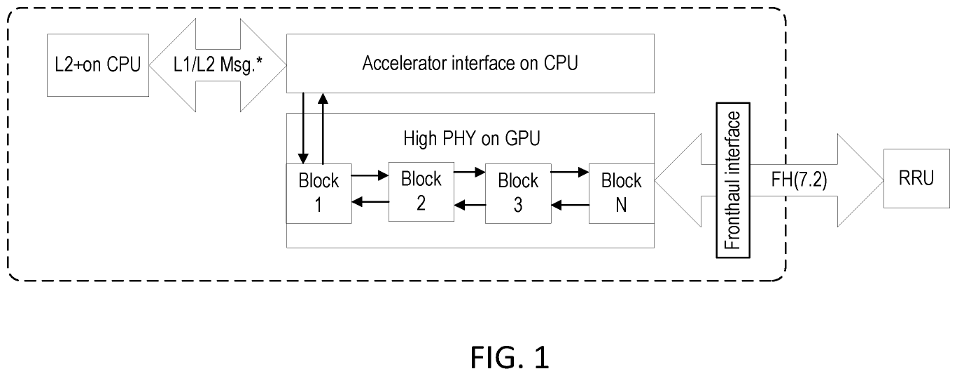

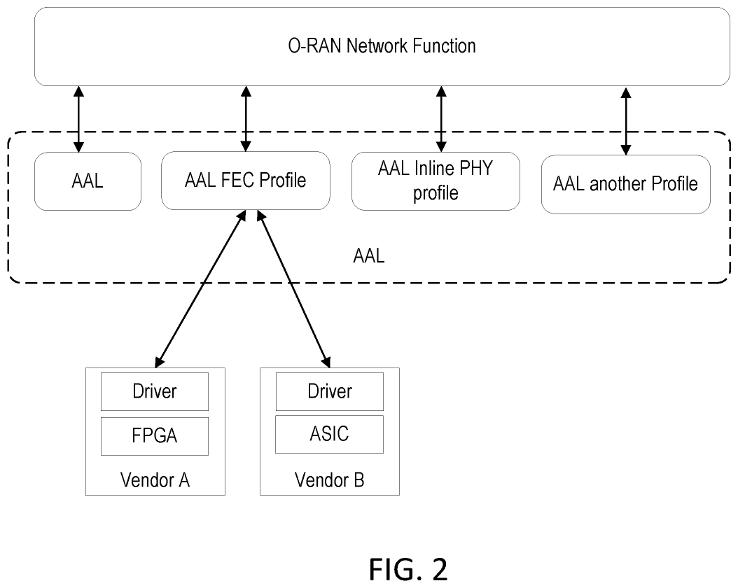

### DETAILED DESCRIPTION

As discussed above, for the type of O-RAN “inline” AAL hardware based accelerators there are currently no defined O-RAN AAL queue assignments, and there are many possible variations of queue assignment. In particular, “inline” AAL hardware device vendors and O-RAN specifications will need to define how the physical layer 1 software and vendor hardware accelerator assign specific data to the queues provided by the AAL inline hardware device, which is currently not defined.

The present disclosure solves at least one problem with existing systems at least in part by mapping layer 2-layer 1 interface messages to O-RAN AAL inline API profile queues. Examples are provided using the FAPI message definitions, but other messaging/signaling definitions that follow a similar logical structure of separating cell control from user path data are equally applicable.

Before describing in detail exemplary embodiments, it is noted that the embodiments reside primarily in combinations of apparatus components and processing steps related to mapping of AAL hardware to AAL queue assignments and/or mapping of physical layer 1 software and AAL hardware and/or providing a logical structure for separating cell control plane messages from user path data. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

In some embodiments, a “layer” such as layer 1 and layer 2 may refer to an open system interconnection (OSI) layer that are known in the art.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node. The term “node” can include network nodes and radio nodes, but is not limited to such.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Transmitting in downlink may pertain to transmission from the network or network node to the terminal. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g., for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

Transmitting logically in the downlink may pertain to transmission from a higher communication layer to a lower communication layer. Transmitting logically in the uplink may pertain to transmission from a lower communication layer to a higher communication layer. Logical transmission may be provided between layers by one or more interfaces as described herein.

A cell may be generally a communication cell, e.g., of a cellular or mobile communication network, provided by a node. A serving cell may be a cell on or via which a node (the node providing or associated to the cell, e.g., base station, gNB or eNodeB) transmits and/or may transmit data (which may be data other than broadcast data) to a user equipment, in particular control and/or user or payload data, and/or via or on which a user equipment/wireless device transmits and/or may transmit data to the node.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide mapping of AAL hardware to AAL queue assignments and/or mapping of physical layer 1 software and AAL hardware and/or providing a logical structure for separating cell control plane messages from user path data.

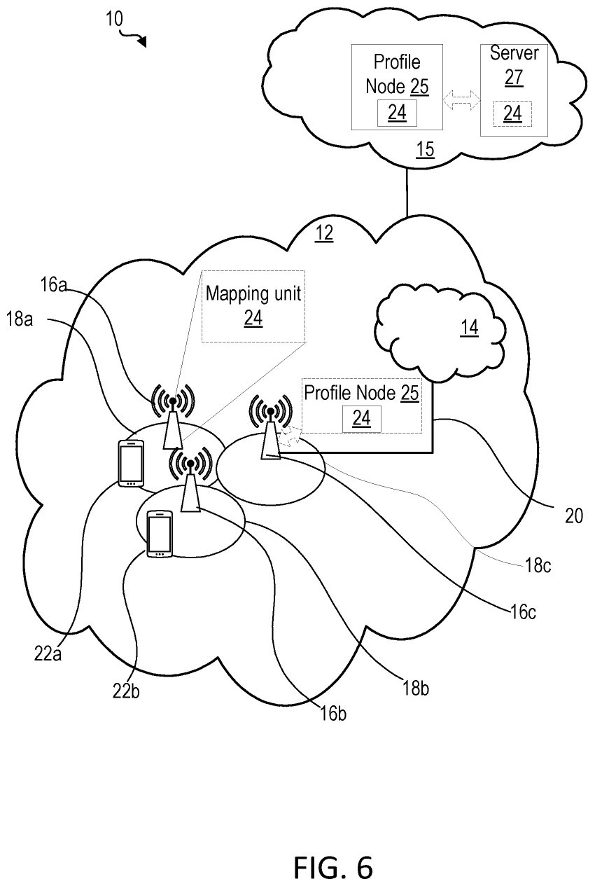

Referring now to the drawing figures, in which like elements are referred to by like reference numerals, there is shown in FIG. 6 a schematic diagram of a communication system 10, according to an embodiment, such as a 3GPP-type cellular network that may support standards such as LTE and/or NR (5G), which comprises an access network 12, such as a radio access network, a core network 14 and intermediate network 15. The access network 12 comprises a plurality of nodes 16a, 16b, 16c (referred to collectively as nodes 16), such as NBs, eNBs, gNBs or other types of wireless access points, each defining a corresponding coverage area 18a, 18b, 18c (referred to collectively as coverage areas 18). Each node 16a, 16b, 16c is connectable to the core network 14 over a wired or wireless connection 20. A first wireless device (WD) 22a located in coverage area 18a is configured to wirelessly connect to, or be paged by, the corresponding node 16a. A second WD 22b in coverage area 18b is wirelessly connectable to the corresponding node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding node 16. Note that although only two WDs 22 and three nodes 16 are shown for convenience, the communication system may include many more WDs 22 and nodes 16.

Also, it is contemplated that a WD 22 can be in simultaneous communication and/or configured to separately communicate with more than one node 16 and more than one type of node 16. For example, a WD 22 can have dual connectivity with a node 16 that supports LTE and the same or a different node 16 that supports NR. As an example, WD 22 can be in communication with an eNB for LTE/E-UTRAN and a gNB for NR/NG-RAN.

In some embodiments, a node 16 may be configured to include a mapping unit 24 which is configured to perform one or more functions as described herein such as with respect to mapping of AAL hardware (i.e., hardware accelerator) to AAL queue (i.e., hardware accelerator queue) assignments and/or mapping of physical layer 1 software and AAL hardware and/or providing a logical structure for separating cell control plane messages from user path data. In some embodiments, mapping unit 24 may be part of management node 25 that is pluggable into, for example, network node 16 for performing one or more functions associated with mapping unit 24.

Intermediate network 15 may be one of, or a combination of more than one of, a public, private or hosted network. The intermediate network 15, if any, may be a backbone network or the Internet. In some embodiments, the intermediate network 15 may comprise two or more sub-networks (not shown). For example, intermediate network 15 may include servers 27 such as cloud servers for performing one or more access network 12 functions. That is, in some embodiments, hardware acceleration for one or more entities in access network 12 are provided by server 27. Intermediate network 15 includes one or more management nodes 25a-25n (collectively referred to as management node 25) that is configured to include mapping unit 24. For example, in some embodiments, management node 25 may be a removably pluggable device that is configured to be plugged into, for example, server 27 to perform one or more functions as described herein such as with respect to mapping of AAL hardware to AAL queue assignments and/or mapping of physical layer 1 software and AAL hardware and/or providing a logical structure for separating cell control plane messages from user path data. In one or more embodiments, a hardware accelerator may provide one or more hardware accelerator queues. Alternatively, in some embodiments, server 27 may be configured with mapping unit 24. Further, “pluggable” and “removably pluggable” as used may refer to physically connecting management node 25 such as via one or more ports to another entity in system 10 such that management node 25 is able to communicate with the other entity, thereby allowing management node 25 to perform the mapping functionality described herein.

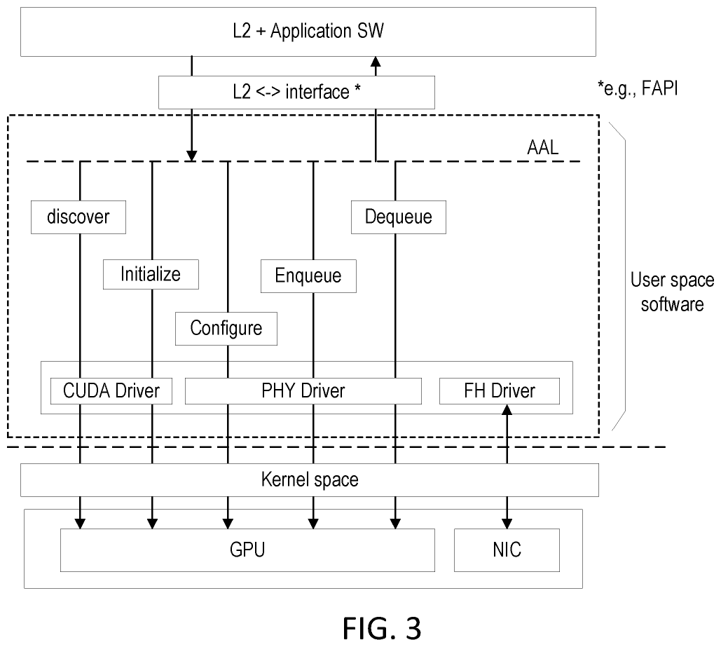

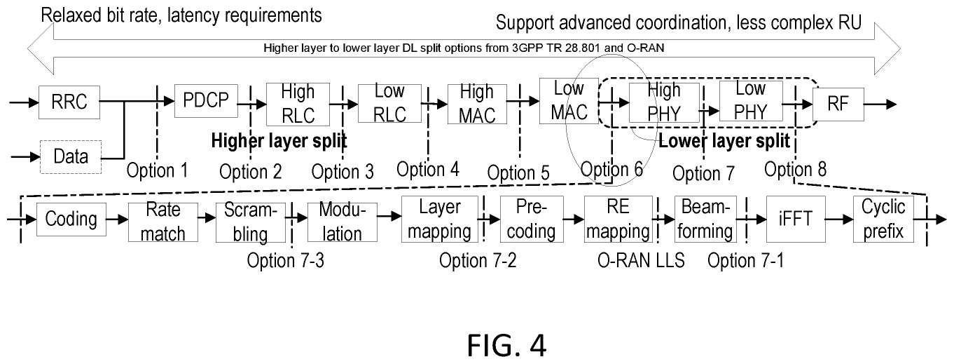

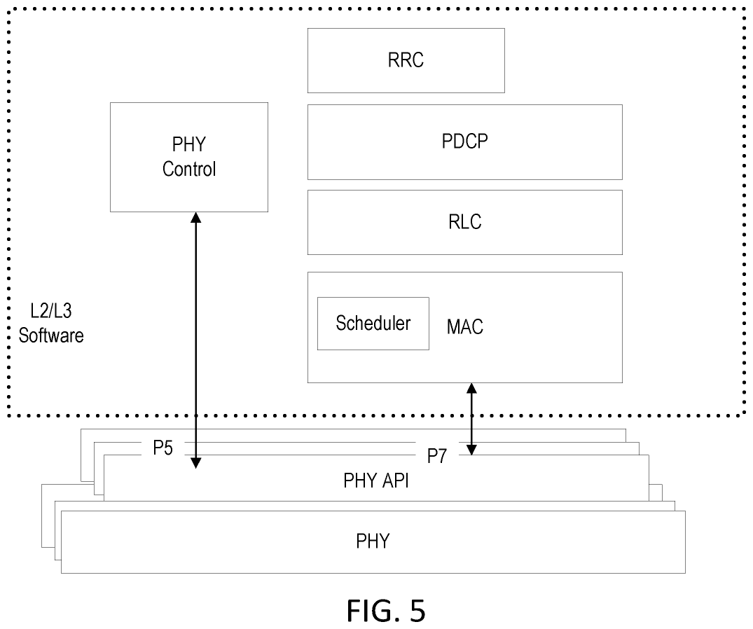

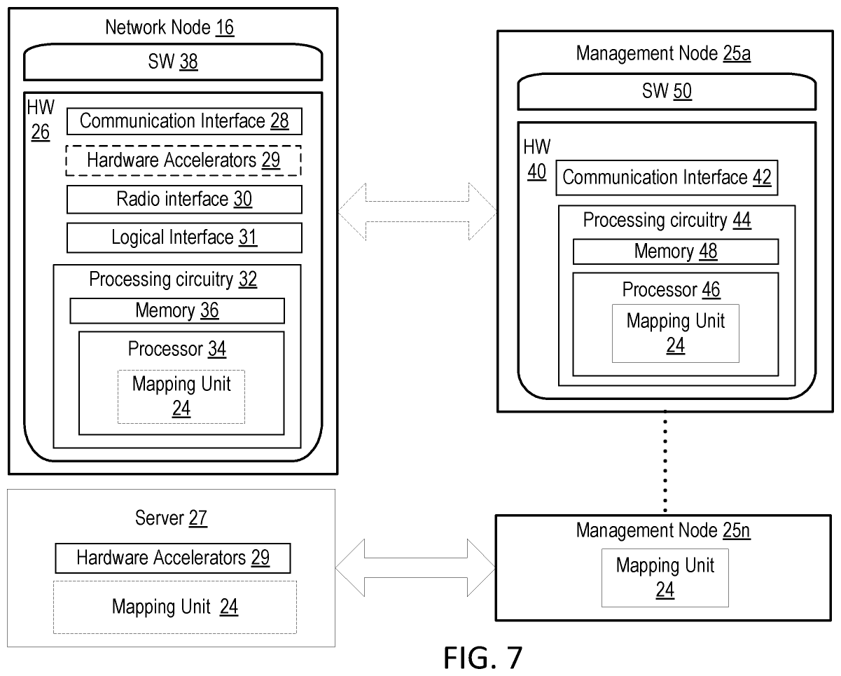

Example implementations, in accordance with an embodiment, of node 16, management node 25 and server 27 discussed in the preceding paragraphs will now be described with reference to FIG. 7. In a communication system 10, a node 16 is provided where node 16 includes hardware 26 enabling it to communicate with the WD 22 and/or provide one or more logical functions/blocks illustrated in FIGS. 3 and/or 5. The hardware 26 may include a communication interface 28 for setting up and maintaining a wired or wireless connection with an interface of a different communication device of the communication system 10, as well as a radio interface 30 for setting up and maintaining at least a wireless connection with a WD 22 located in a coverage area 18 served by network node 16. The radio interface 30 may be formed as or may include, for example, one or more RF transmitters, one or more RF receivers, and/or one or more RF transceivers. In one or more embodiments, the logical interface 31 may be configured to provide one or more logical functions/blocks illustrated in FIGS. 3 and/or 5 such as providing an interface between layer 1 functions and layer 2 function as described herein.

In some embodiments, network node 16 may include one or more hardware accelerators 29 that are configured to offload one or more operations (e.g., processing one or more Femto API (FAPI) interface messages) from, for example, processing circuitry 32 and/or processor 34. In the embodiment shown, the hardware 26 of network node 16 further includes processing circuitry 32. The processing circuitry 32 may include a processor 34 and a memory 36. In particular, in addition to or instead of a processor, such as a central processing unit, and memory, the processing circuitry 32 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 34 may be configured to access (e.g., write to and/or read from) the memory 36, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, network node 16 further has software 38 stored internally in, for example, memory 36, or stored in external memory (e.g., database, storage array, network storage device, etc.) accessible by network node 16 via an external connection. The software 38 may be executable by the processing circuitry 32. The processing circuitry 32 may be configured to control any of the methods and/or processes described herein and/or to cause such methods, and/or processes to be performed, e.g., by network node 16. Processor 34 corresponds to one or more processors 34 for performing network node 16 functions described herein. The memory 36 is configured to store data, programmatic software code and/or other information described herein. In some embodiments, the software 38 may include instructions that, when executed by the processor 34 and/or processing circuitry 32, causes the processor 34 and/or processing circuitry 32 to perform the processes described herein with respect to network node 16. For example, processing circuitry 32 of the network node 16 may include mapping unit 24 configured to perform one or more network node 16 functions as described herein such as with respect to mapping of AAL hardware to AAL queue assignments and/or mapping of physical layer 1 software and AAL hardware. In some embodiments, if mapping unit 24 is not included in network node 16, but network node 16 includes hardware accelerator 29, then mapping unit 24 functionality may be provided to network node 16 by plugging management node 25 into network node 16. Alternatively, if network node 16 does not include both hardware accelerators 29 and mapping unit 24, then offloading of one or more network node 16 functions may be provided by hardware accelerator(s) 29 at server 27. As described below, server 27 may be configured to include mapping unit 24 or may be configured to accept mapping unit 24 functionality via management node 25.

The communication system 10 further includes management node 25 already referred to. Management node 25 includes hardware 40 enabling it to communicate an entity in system 10. The hardware 40 may include a communication interface 42 for setting up and maintaining a connection with an interface of a different communication device of the communication system 10.

In the embodiment shown, the hardware 40 of management node 25 further includes processing circuitry 44. The processing circuitry 44 may include a processor 46 and a memory 48. In particular, in addition to or instead of a processor, such as a central processing unit, and memory, the processing circuitry 44 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 46 may be configured to access (e.g., write to and/or read from) the memory 48, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). Thus, management node 25 further has software 50 stored internally in, for example, memory 48, or stored in external memory (e.g., database, storage array, network storage device, etc.) accessible by management node 25 via an external connection. The software 50 may be executable by the processing circuitry 44. The processing circuitry 44 may be configured to control any of the methods and/or processes described herein and/or to cause such methods, and/or processes to be performed, e.g., by management node 25. Processor 46 corresponds to one or more processors 46 for performing management node 25 functions described herein. The memory 48 is configured to store data, programmatic software code and/or other information described herein. In some embodiments, the software 50 may include instructions that, when executed by the processor 46 and/or processing circuitry 44, causes the processor 46 and/or processing circuitry 44 to perform the processes described herein with respect to management node 25. For example, processing circuitry 44 of management node 25 may include mapping unit 24 configured to perform one or more functions as described herein such as with respect to mapping of AAL hardware to AAL queue assignments and/or mapping of physical layer 1 software and AAL hardware. In some embodiments, the AAL hardware may part of server 27, network node 16 or another entity in communication system 10 that management node 25 is configured to communicate with such as to management the mapping.

The communication system 10 further includes server 27 already referred to. Server 27 may include hardware and software similar to network node 16 for performing one or more server functions such as providing one or more cloud network functions. In one or more embodiments, server 27 may include one or more hardware accelerators 29 that are described above. Further, management node 25 may be pluggable into a port (e.g., communication port) of server 27 such that management node 25 is able to management mapping of messages for hardware accelerators 29 in server 27.

In some embodiments, the inner workings of the network node 16 and management node 25 may be as shown in FIG. 7 and independently, the surrounding network topology may be that of FIG. 6. Although FIGS. 6 and 7 show “unit” such as mapping unit 24 as being within a respective processor, it is contemplated that this unit may be implemented such that a portion of the unit is stored in a corresponding memory within the processing circuitry. In other words, the unit may be implemented in hardware or in a combination of hardware and software within the processing circuitry.

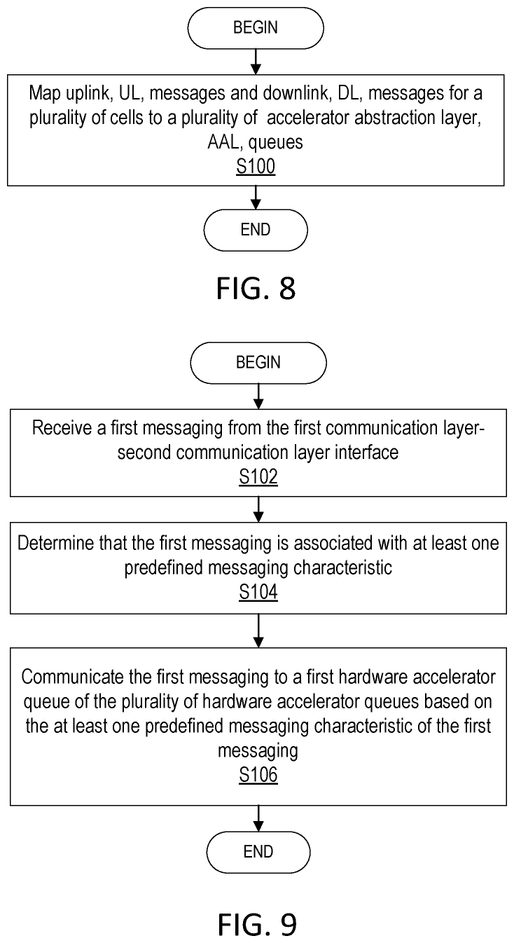

FIG. 8 is a flowchart of an exemplary process in a management node 25 according to some embodiments of the present disclosure. One or more Blocks and/or functions performed by node 25 may be performed by one or more elements of management node 25 such as by mapping unit 24 in processing circuitry 44, processor 46, communication interface 42, etc. In one or more embodiments, management node 25 is configured to map (Block S134) uplink, UL, messages and downlink, DL, messages for a plurality of cells to a plurality of accelerator abstraction layer, AAL, queues, as described herein.

According to one or more embodiments, each cell is configured with a first AAL queue pair and a second AAL queue pair of the plurality of AAL queues where the UL and DL messages include: UL and DL C-Plane (i.e., control plane) and/or U-Plane (i.e., user plane) messages that are mapped to the first queue pair; and UL and DL configuration messages that are mapped to the second queue pair, as described herein. According to one or more embodiments, each cell is configured with a respective AAL queue pair of the plurality of AAL queues for the UL and DL messages for the cell where the UL and DL messages include UL and DL C-Plane and/or U-Plane messages and UL and DL configuration messages for the cell, as described herein. According to one or more embodiments, the plurality of cells configured with a single queue pair corresponding to the plurality of AAL queues for the UL and DL messages for the plurality of cells where the UL and DL messages include C-Plane and/or U-Plane messages and UL and DL configuration messages for the plurality of cells.

FIG. 8 is a flowchart of an exemplary process in a management node 25 according to some embodiments of the present disclosure. One or more Blocks and/or functions performed by management node 25 may be performed by one or more elements of management node 25 such as by mapping unit 24 in processing circuitry 44, processor 46, communication interface 42, etc. In one or more embodiments, management node 25 is configured to receive (Block S136) a first messaging from the first communication layer-second communication layer interface, as described herein. In one or more embodiments, management node 25 is configured to determine (Block S138) that the first messaging is associated with at least one predefined messaging characteristic, as described herein. In one or more embodiments, management node 25 is configured to communicate (Block S140) the first messaging to a first hardware accelerator 29 queue of the plurality of hardware accelerator 29 queues based on the at least one predefined messaging characteristic of the first messaging, as described herein.

According to one or more embodiments, the at least one predefined messaging characteristic is associated with at least one of: one of uplink and downlink messaging, cell specific messaging, and sub-interface type messaging. According to one or more embodiments, the first messaging is one of: physical downlink shared channel, PDSCH, messaging, physical downlink control channel, PDCCH, messaging, physical broadcast channel, PBCH, messaging, and reference signal messaging. According to one or more embodiments, each of the plurality of hardware accelerator 29 queues are associated with one of a plurality of respective groups of messaging characteristics where the communicating of messaging from the first communication layer-second communication layer interface to one of the plurality of hardware accelerators 29 queues is based on whether the messaging corresponds to one of the plurality of respective groups of messaging characteristics.

According to one or more embodiments, a first group of messaging characteristics of the plurality of respective groups of messaging characteristics for the first hardware accelerator 29 queue corresponds to uplink messaging for sub-interface messaging for a plurality of cells. A second group of messaging characteristics of the plurality of respective groups of messaging characteristics for a second hardware accelerator 29 queue of the plurality of hardware accelerator 29 queues corresponds to downlink messaging for sub-interface messaging for a plurality of cells. According to one or more embodiments, each hardware accelerator 29 queue of the plurality of hardware accelerator 29 queues is associated with a respective one of uplink and downlink messaging of a respective cell. According to one or more embodiments, the respective one of uplink and downlink messaging includes: first sub-interface messaging associated with the first communication layer, and a second sub-interface messaging associated with the first communication layer.

According to one or more embodiments, the respective one of uplink and downlink messaging includes only one of: a first sub-interface messaging associated with the first communication layer, and a second sub-interface messaging associated with the first communication layer. According to one or more embodiments, the first sub-interface messaging corresponds to P5 messaging and the second sub-interface messaging corresponds to P7 messaging. According to one or more embodiments, the plurality of hardware accelerator 29 queues corresponds to first communication layer hardware accelerator 29 queues for performing inline interface processing.

According to one or more embodiments, the management node 25 is configured to be pluggable into a server 27 to manage the data exchange between the first communication layer-second communication layer interface of the server 27 and the plurality of hardware accelerator 29 queues of the server 27. According to one or more embodiments, the node is configured to be pluggable into a network node 16 to manage the data exchange between the first communication layer-second communication layer interface of the network node 16 and the plurality of hardware accelerator 29 queues of the network node 16.

Having generally described arrangements for mapping of AAL hardware/device (which may correspond to one or more elements of hardware 26 and/or hardware 40) to AAL queue assignments and/or mapping of physical layer 1 software and AAL hardware and/or providing a logical structure for separating cell control plane messages from user path data, functions and processes are provided as follows, and which may be implemented by the management node 25 or network node 16. Further, while mapping unit 24 and functionality related to mapping as described as being performed at management node 25, one or more functions of management node 25 may be performed by another entity that is configured to provide one or more mapping unit 24 functions.

Some embodiments provide mapping of AAL hardware to AAL queue assignments and/or mapping of physical layer 1 software and AAL hardware and/or providing a logical structure for separating cell control plane messages from user path data. In one or more functions described below may be provided by one or more of processing circuitry 44, processor 46, mapping unit 24, etc.

One or more embodiments described herein relate to how FAPI-like PHY API messages are mapped to O-RAN AAL queues (e.g., hardware accelerator 29 queues). For example, FIG. 9 illustrates three example mappings of FAPI P5 (also referred to as P5) and FAPI P7 (also referred to as P7) interface messages to O-RAN AAL queues.

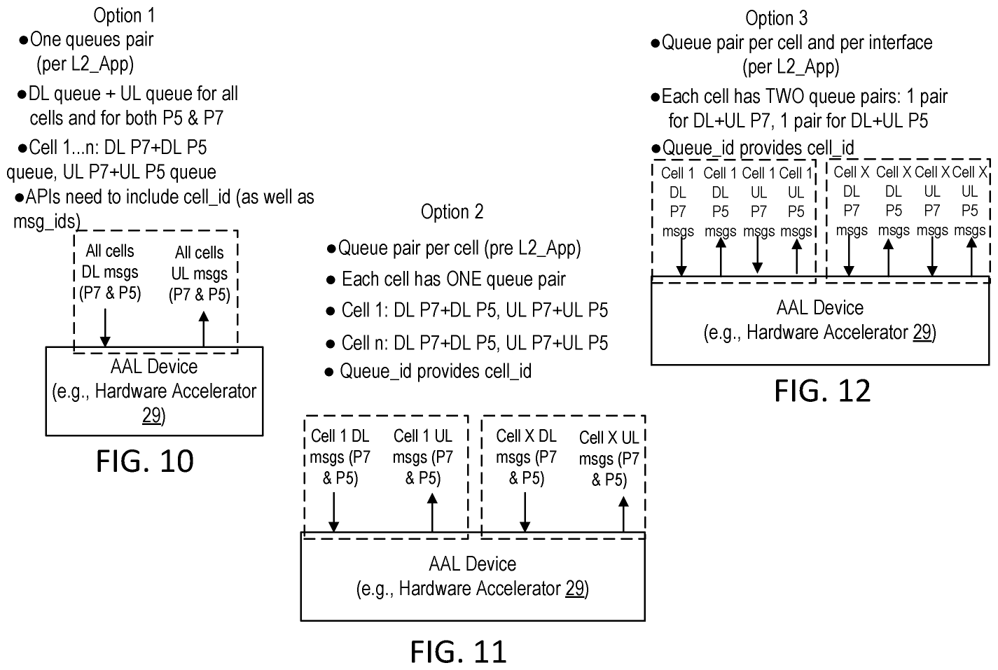

Referring to FIG. 10, in option 1, all FAPI DL for both P5 and P7 messages for all cells 18 are mapped to a single AAL API queue such as by management node 25 and/or as performed by mapping unit 24. All FAPI UL for both P5 and P7 messages for all cells 18 are mapped to another AAL API queue. In one or more embodiments, “mapping” may refer to implementing a predefined assignment and/or configuration.

Referring to FIG. 11, in option 2: AAL API queue pairs are used where each queue pair may be specific for a NR or LTE cell 18, i.e., all FAPI DL for both P5 and P7 messages for a specific cell 18 are mapped to a single AAL API queue. All FAPI UL for both P5 (i.e., configuration, cell management, etc.) and P7 (i.e., C-Plane and U-Plane) messages for the same specific cell are mapped to another AAL API queue. Multiple cells 18 then have independent queue pairs for the AAL device. One or more of the multiple cells 18 may be provided by node 16.

Referring to FIG. 12, in Option 3, which may include separating queue pairs by cell 18, separate queues are used for FAPI P5 and P7 interface messages.

For example, the FAPI message to queue mapping for option 3 based on the above description is:

Mapping of FAPI C-Plane & U-Plane Messaging (P7) to ORAN AAL device Queues:

| AAL Queue | Queue Direction | FAPI Message Mapping |
|---|---|---|
| DL CU Queue | L2 → L1 AAL | DL_TTI.Request |
| [1 . . . n] | Device | TX_DATA.Request |
| | | UL_DCI.Request |
| | | UL_TTI.Request |
| UL CU Queue | L1 AAL Device → | SLOT.Indication |
| [1 . . . n] | L2 | CRC.Indication |
| | | RX_DATA.Indication |
| | | UCI.Indication |
| | | RACH.Indication |
| | | SRS.Indication |
| | | ERROR.Indication* |

Mapping of FAPI Configuration Messaging (P5) to 0-RAN AAL device Queues:

| AAL Queue | Queue Direction | FAPI Message Mapping |
|---|---|---|
| DL Config Queue | L2 → L1 AAL | PARAM.request |
| [1 . . . n] | Device | CONFIG.request |
| | | START.request |
| | | STOP.request |
| UL Config Queue | L1 AAL Device → | PARAM.response |
| [1 . . . n] | L2 | CONFIG.response |
| | | STOP.Indication |
| | | ERROR.Indication* |

In particular, there is a queue pair (UL & DL) for P7 messages for each cell (n), and a queue pair (UL & DL) for P5 messages for each cell (n), i.e., each cell uses two pairs of queues (4 queues in total).

More generally, for each O-RAN cell: L2-L1 messages for cell management (P5 FAPI messages used in the examples above) may use 1 pair of O-RAN AAL queues, while L2-L1 messages pertaining to the main data path (P7 FAPI messages used in the examples above) may use a separate pair of O-RAN AAL queues.

Therefore, one or more embodiments described herein define mappings of L2 messages/signals to O-RAN AAL device queues that may be included in the O-RAN AAL specifications, where the mappings may be performed by management node 25 and/or mapping unit 24. Further, one or more embodiments provide one or more of the following advantages:
The assignments described here provide logical and efficient assignment of inline AAL device queues to data that may be transferred between the physical layer 1 software and AAL hardware device (i.e., hardware accelerator 29).
One or more of the message< >queue assignments described herein may be defined in the O-RAN AAL API specification which may then be used by any 0-RAN AAL vendor and O-RAN inline profile baseband SW vendor.
While the disclosure describes mapping FAPI messages to queues as an example, however, the FAPI messages can be generalized to a set of generic messages not tied to the Small Cell Forum FAPI message definitions such that management node 25 and/or mapping unit 24 may be configured to map/managed other types of messages to specific queues.

### EXAMPLES

Example A1. A node 16/25 configured to, and/or comprising a radio interface 30 and/or comprising processing circuitry 32/44 configured to:
map uplink, UL, messages and downlink, DL, messages for a plurality of cells 18 to a plurality of accelerator abstraction layer, AAL, queues.

Example A2. The node 16/25 of Example A1, wherein each cell is configured with a first AAL queue pair and a second AAL queue pair of the plurality of AAL queues, the UL and DL messages include:
UL and DL C-Plane and/or U-Plane messages that are mapped to the first queue pair,
UL and DL configuration messages that are mapped to the second queue pair.

Example A3. The node 16/25 of Example A1, wherein each cell is configured with a respective AAL queue pair of the plurality of AAL queues for the UL and DL messages for the cell 18, the UL and DL messages including UL and DL C-Plane and/or U-Plane messages and UL and DL configuration messages for the cell 18.

Embodiment A4. The node 16/25 of Example A1, wherein the plurality of cells 18 configured with a single queue pair corresponding to the plurality of AAL queues for the UL and DL messages for the plurality of cells 18, the UL and DL messages including C-Plane and/or U-Plane messages and UL and DL configuration messages for the plurality of cells 18.

Example B1. A method implemented by a node 16/25, the method comprising:
mapping uplink, UL, messages and downlink, DL, messages for a plurality of cells 18 to a plurality of accelerator abstraction layer, AAL, queues.

Example B2. The method of Example B1, wherein each cell is configured with a first AAL queue pair and a second AAL queue pair of the plurality of AAL queues, the UL and DL messages include:
UL and DL C-Plane and/or U-Plane messages that are mapped to the first queue pair; and
UL and DL configuration messages that are mapped to the second queue pair.

Example B3. The method of Example B1, wherein each cell 18 is configured with a respective AAL queue pair of the plurality of AAL queues for the UL and DL messages for the cell 18, the UL and DL messages including UL and DL C-Plane and/or U-Plane messages and UL and DL configuration messages for the cell 18.

Example B4. The method of Example B1, wherein the plurality of cells 18 configured with a single queue pair corresponding to the plurality of AAL queues for the UL and DL messages for the plurality of cells 18, the UL and DL messages including C-Plane and/or U-Plane messages and UL and DL configuration messages for the plurality of cells 18.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| AAL | Accelerator Abstraction Layer |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A node for managing data exchange between a first communication layer-second communication layer interface and a plurality of hardware accelerator queues, the first layer being different from the second communication layer, the node comprising:
processing circuitry configured to:
receive a first messaging from the first communication layer-second communication layer interface;
determine that the first messaging is associated with at least one predefined messaging characteristic; and
communicate the first messaging to a first hardware accelerator queue of the plurality of hardware accelerator queues based on the at least one predefined messaging characteristic of the first messaging.

2. The node of claim 1, wherein the at least one predefined messaging characteristic is associated with at least one of:
one of uplink and downlink messaging;
cell specific messaging; and
sub-interface type messaging.

3. The node of claim 1, wherein the first messaging is one of:
physical downlink shared channel, PDSCH, messaging;
physical downlink control channel, PDCCH, messaging;
physical broadcast channel, PBCH, messaging; and
reference signal messaging.

4. The node of claim 1, wherein each of the plurality of hardware accelerator queues are associated with one of a plurality of respective groups of messaging characteristics, the communicating of messaging from the first communication layer-second communication layer interface to one of the plurality of hardware accelerator queues being based on whether the messaging corresponds to one of the plurality of respective groups of messaging characteristics.

5. The node of claim 4, wherein a first group of messaging characteristics of the plurality of respective groups of messaging characteristics for the first hardware accelerator queue corresponds to uplink messaging for sub-interface messaging for a plurality of cells; and
a second group of messaging characteristics of the plurality of respective groups of messaging characteristics for a second hardware accelerator queue of the plurality of hardware accelerator queues corresponds to downlink messaging for sub-interface messaging for a plurality of cells.

6. The node of claim 1, wherein each hardware accelerator queue of the plurality of hardware accelerator queues is associated with a respective one of uplink and downlink messaging of a respective cell.

7. The node of claim 6, wherein the respective one of uplink and downlink messaging includes:
first sub-interface messaging associated with the first communication layer; and
a second sub-interface messaging associated with the first communication layer.

8. The node of claim 6, wherein the respective one of uplink and downlink messaging includes only one of:
a first sub-interface messaging associated with the first communication layer; and
a second sub-interface messaging associated with the first communication layer.

9. The node of claim 7, wherein the first sub-interface messaging corresponds to femto application platform interface, FAPI, P5 messaging and the second sub-interface messaging corresponds to FAPI P7 messaging.

10. The node of claim 1, wherein the plurality of hardware accelerator queues corresponds to first communication layer hardware accelerator queues for performing inline interface processing.

11. The node of claim 1, wherein the node is configured to be pluggable into a server to manage the data exchange between the first communication layer-second communication layer interface of the server and the plurality of hardware accelerator queues of the server.

12. The node of claim 1, wherein the node is configured to be pluggable into a network node to manage the data exchange between the first communication layer-second communication layer interface of the network node and the plurality of hardware accelerator queues of the network node.

13. The node (25) of claim 1, wherein the first communication layer corresponds to open systems interconnection, OSI, layer 1 and the second communication layer corresponds to open systems interconnection, OSI, layer 2.

14. A method implemented by a node for managing data exchange between a first communication layer-second communication layer interface and a plurality of hardware accelerator queues, the first layer being different from the second communication layer, the method comprising:
receiving a first messaging from the first communication layer-second communication layer interface;
determining that the first messaging is associated with at least one predefined messaging characteristic; and
communicating the first messaging to a first hardware accelerator queue of the plurality of hardware accelerator queues based on the at least one predefined messaging characteristic of the first messaging.

15. The method of claim 14, wherein the at least one predefined messaging characteristic is associated with at least one of:
one of uplink and downlink messaging;
cell specific messaging; and
sub-interface type messaging.

16. The method of claim 14, wherein the first messaging is one of:
physical downlink shared channel, PDSCH, messaging;
physical downlink control channel, PDCCH, messaging;
physical broadcast channel, PBCH, messaging; and
reference signal messaging.

17. The method of claim 14, wherein each of the plurality of hardware accelerator queues are associated with one of a plurality of respective groups of messaging characteristics, the communicating of messaging from the first communication layer-second communication layer interface to one of the plurality of hardware accelerator queues being based on whether the messaging corresponds to one of the plurality of respective groups of messaging characteristics.

18. The method of claim 17, wherein a first group of messaging characteristics of the plurality of respective groups of messaging characteristics for the first hardware accelerator queue corresponds to uplink messaging for sub-interface messaging for a plurality of cells; and
a second group of messaging characteristics of the plurality of respective groups of messaging characteristics for a second hardware accelerator queue of the plurality of hardware accelerator queues corresponds to downlink messaging for sub-interface messaging for a plurality of cells.

19. The method of claim 14, wherein each hardware accelerator queue of the plurality of hardware accelerator queues is associated with a respective one of uplink and downlink messaging of a respective cell.

20. The method of claim 19, wherein the respective one of uplink and downlink messaging includes:
first sub-interface messaging associated with the first communication layer; and
a second sub-interface messaging associated with the first communication layer.

21. The method of claim 19, wherein the respective one of uplink and downlink messaging includes only one of:
a first sub-interface messaging associated with the first communication layer; and
a second sub-interface messaging associated with the first communication layer.

22. The method of claim 20, wherein the first sub-interface messaging corresponds to femto application platform interface, FAPI, P5 messaging and the second sub-interface messaging corresponds to FAPI P7 messaging.

23. The method of claim 14, wherein the plurality of hardware accelerator queues corresponds to first communication layer hardware accelerator queues for performing inline interface processing.

24. The method of claim 14, wherein the node is configured to be pluggable into a server to manage the data exchange between the first communication layer-second communication layer interface of the server and the plurality of hardware accelerator queues of the server.

25. The method of claim 14, wherein the first communication layer corresponds to open systems interconnection, OSI, layer 1 and the second communication layer corresponds to open systems interconnection, OSI, layer 2.

26. A computer readable medium comprising instructions that when executed by a processor cause the processor to:
receive a first messaging from a first communication layer-second communication layer interface;
determine that the first messaging is associated with at least one predefined messaging characteristic; and
communicate the first messaging to a first hardware accelerator queue of a plurality of hardware accelerators queues based on the at least one predefined messaging characteristic of the first messaging.
